(19) United States
(12) Patent Application Publication
(10) Pub. No.: US 2004/0246122 A1
(43) Pub. Date: Dec. 9, 2004

(54) Detection system and signaling device

(76) Inventor: Robert T. Bailey III, Lakewood, NJ (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/457,027

(22) Filed: Jun. 6, 2003

(51) Int. Cl. G08B 29/00

(52) U.S. Cl. 340/506; 340/541

(57) ABSTRACT

A system for monitoring activity includes a detector located in a desired area, such as shower, and a receiver installed in an area remote from the detector, such as a powder room. The detector detects movement in the shower and sends an activation signal to the receiver. The receiver receives the activation signal and sends an alarm indication signal to a signal device. The signal device produces an alarm signal to notify any individual at the remote area that the shower is occupied. The system may also include a detector mounted to a delivery receptacle, such as a mailbox. The detector detects motion in the delivery receptacle and sends a signal to a receiver to activate a signal device. The signal device produces an alarm to notify individuals that the receptacle had been opened.

### FIELD OF THE INVENTION

The present invention relates to motion detection methods and systems, and particularly to motion sensors and signals for use at the home.

### BACKGROUND

In many buildings, such as residential homes, it is desirable to monitor activity in and around the building without having to physically inspect those areas. For example, it is often convenient to know when a person is using a washroom shower in the building. Many buildings, such as older houses, have plumbing systems that distribute a limited amount of water pressure to washrooms. Individuals who use showers with lower water pressure can experience a significant drop in water pressure when plumbing is turned on at other locations in the building. For example, when cold water is turned on in the shower and subsequently turned on at other locations, the shower user may experience a sudden loss of cold water. When hot water is turned on in the shower and subsequently turned on at other locations in the plumbing system, the shower user may experience a sudden loss of hot water. In many cases, loss of water pressure in the shower is inadvertently caused by individuals who use the plumbing without knowledge that someone is using the shower. Therefore, it is desirable to have a mechanism that detects when a shower is occupied and notifies individuals on the premises that the shower is occupied.

A similar need exists for detecting events outside of the home, such as the delivery of mail. In many homes, mail is received in mailboxes located several feet away from the house. On farms and other large properties, the mailbox may be located several hundred feet from the residence. Since the mailbox is located away from the house, the delivery of the mail is seldom witnessed by individuals in the house. Therefore, individuals who are uncertain as to whether mail has been delivered must physically inspect the mailbox and experience the possibility of checking the mailbox before the mail has been delivered. For most individuals, it is desirable to avoid inspecting the mailbox before the mail has been delivered.

### SUMMARY OF THE INVENTION

The present invention provides a system and method for monitoring activity in and around a building or home. In a first embodiment of the invention, the system includes a main detector, such as a motion detector, installed in proximity to a washroom shower. When a person enters the shower area in preparation for taking a shower, the detector detects the presence of a person in the shower, such as a motion detector detecting movement, and produces a first output signal. A receiver installed at a selected remote location, or at a plurality of such locations, receives the first output signal from the motion detector and activates one or more alarm or notification indicators to notify individuals present at the remote location that the shower is occupied. Typically, the receiver, or at least the alarm indicator or indicators for such receiver, will be located at a selected remote location, such as a central location or a location having another water source, such as a sink, water faucet, washing machine, toilet, bath tub, additional shower or the like. In fact, a receiver, or at least the alarm indicators, may be located at any or all such locations. The alarm indicator may take the form of an audible alarm, such as an audio speaker or a visual alarm such as a warning light. An alarm magnitude selector may be provided to enable the user to adjust a selected characteristic like the magnitude, i.e., volume, intensity or number of indicators, of the alarm. The alarm indicators may be activated in a continuous or periodic mode at least during the time period that the presence of a person is detected in the shower. The alarm indicator may also be activated for a predetermined time period that may be selectable or adjustable by the user using an alarm time period selection input. The alarm indicator may also operate in either a continuous or a periodic mode until manually reset by the user using a manual reset button, or the indicator may be automatically reset when the detector no longer detects the presence of a person in the shower. When reset, the system will deactivate thereby discontinuing the alarm. The system may immediately reset to again detect the presence of a person in the shower or the system may reset after a predetermined time out period following activation of the reset button. Alternatively, a time out selector may be provided to enable the user to select the time out period that the alarm will remain deactivated following activation of the alarm reset. The alarm indicator may simply remain activated until the detector no longer detects the presence of a person in the shower. Optionally, the system may include a local detector positioned at the location of a selected one or more of the alarm indicators in some or all of the remote locations. The local detector functions to detect the presence of a user in the vicinity of the alarm indicator and to enable the receiver to produce an alarm at the alarm indicator in response to the detection of a person in the shower by the main detector. Accordingly, even though the main detector detects the presence of a person in the shower, the alarm indicator will not activate until the local detector in the vicinity of the alarm indicator detects the presence of a user in the vicinity of the alarm indicator. In a selected configuration and mode of operation, the alarm indicator will provide an alarm as long as both the main detector detects the presence of a person in the shower and the local detector detects a user in the vicinity of the alarm indicator. If either detector fails to detect, then the alarm indicator will automatically shut off.

In a second embodiment of the invention, the system may include, as an alternative to the first embodiment or as an addition to the first embodiment, a mailbox detector mounted in proximity to a mail receptacle, such as a mailbox. The detector may be in the form of a motion detector to detect motion at the delivery receptacle, such as motion caused by placement of mail in the mailbox, and in response the detector may produce a first output signal. As an alternative, the mailbox detector may be in some other suitable form, such as an infrared detector, including a series of detector units, positioned on or within the mailbox to detect the presence of an object within the mailbox. A receiver is installed at a location remote from the receptacle. The receiver receives the first output signal from the motion detector and activates an alarm signal to alert individuals present at the remote location when a delivery is detected at the receptacle.

### DESCRIPTION OF THE DRAWINGS

The foregoing summary as well as the following description will be better understood when read in conjunction with the accompanying drawings in which:

FIG. 1 is a block diagram of an embodiment of a detection system in accordance with the present invention.

FIG. 2 is a block diagram of an embodiment of the detection system of the present invention illustrating a selected arrangement of components of the detection system within a house.

FIG. 3 is a block diagram of the detection system of the present invention illustrating the use of a local detector for use in detecting the presence of a user in the vicinity of an alarm indicator, such as an audio speaker or light indicator such as an LED, for the purpose of enabling a main detector to activate the alarm indicators when the main detector also effects a detection.

FIG. 4 is a block diagram of an embodiment of the detection system used for the detection of mail at a mailbox.

### DETAILED DESCRIPTION OF THE PREFERRED EMBODIMENT

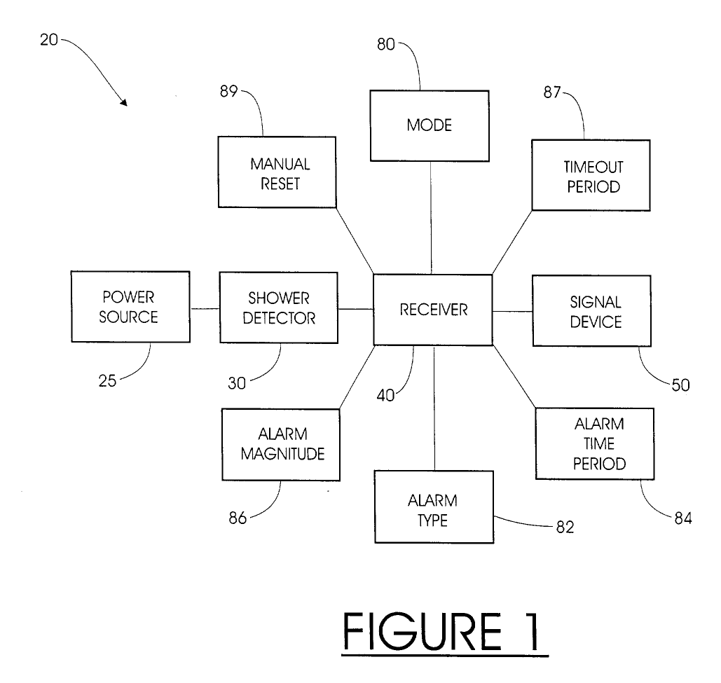

Referring to the drawings generally, and to FIG. 1 in particular, a detection system, generally designated 20, in accordance with the present invention is shown. The detection system 20 is configured to detect the potential presence of a person in a shower stall and, in response, notify other individuals in the building, or at selected locations within the building, that the shower stall is occupied. A main detector 30 mounted in the shower stall detects the presence of a person in the shower stall and sends a first output signal to a receiver 40 installed in another room in the building. The receiver 40 activates a signal device 50 to alert individuals in the vicinity of the signal device that the shower stall is occupied. In this way, individuals can limit or avoid running water in the building while the shower stall is occupied.

The detector 30 is mounted in the vicinity of the shower head to detect motion in the shower. The detector 30 may, for example, be in the form of a motion detector which is focused on a small zone or space beneath the shower head, and perhaps above the floor, to detect motion directly beneath the shower head. Focusing the zone of detection limits the potential for the detection system to detect motion outside of an empty shower stall and produce a false or misleading signal indicating that the shower stall is occupied. Focusing the zone of detection above the floor will prevent a pet at floor level from being falsely detected as a person in the shower. The detector 30 may also take the form, for example, of an infrared light detector to detect the presence of an object in the shower. The infrared detector may include separate detector units directed across the shower stall to detect a presence within the stall. The separate units can be positioned at appropriate vertical and horizontal locations to effect the proper detection of a person while inhibiting detection below a selected general height such as 2 to 3 feet, for example. A variety of sensors may be used with the detector 30.

In response to the detection of a presence in the shower, the detector produces a signal for transmission as a first output signal. The motion detector is operatively connected to a source of power 25. For example, the detector 30 may be wired into the building's electrical system and mounted above the shower head to minimize contact with water in the shower.

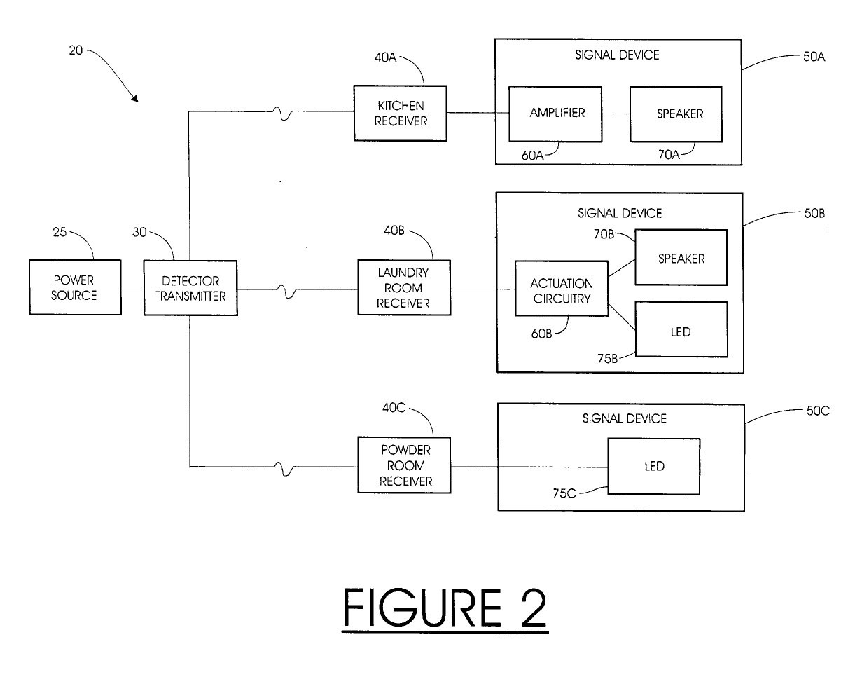

The detector 30 operatively cooperates with one or more receivers 40 to transmit the output signal to one or more of the receivers 40. The detector 30 functions as a transmitter to transmit an activation signal as an output signal to the one or more receivers disposed at desired remote locations. The detector may transmit the output signal through air, for example, by a short distance radio signal, to the receiver 40. Alternatively, the detector 30 may be electrically connected with the receiver 40 by electrical wiring. The detection system 20 may include separate receivers 40 installed in one or more rooms in the building. The receivers 40 may be mounted on walls or backsplashes above locations where plumbing is used, including but not limited to, walls above sinks, toilets, dishwashers, washing machines, bathtubs, and outdoor spigots. Receivers 40 may also be mounted in common or central areas, such as family rooms and hallways. Referring to FIG. 2, the detection system 20 includes a detector 30 operatively communicating with three different receivers 40A, 40B, 40C. The receivers 40A, 40B, 40C are installed, for example, in a kitchen, a laundry room, and a powder room, respectively, where the building plumbing system is often used.

The receivers 40A, 40B, 40C are configured to receive a first output activation signal from the detector 30 when motion or a presence is detected in the shower stall by the detector 30. In response to the reception of an activation signal from the detector, the receiver produces an alarm indication signal. The receivers 40A, 40B, 40C are operatively connected with signal devices 50A, 50B, 50C, respectively, which function to provide a desired alarm indication of a user in response to the alarm indication signal. The signal device may be provided through signal circuitry as a part of the receiver or as a separate device or circuitry, in whole or in part, from the receiver. The signal devices are adapted to receive the output alarm indication signal from their associated receivers and to activate an alarm indication, such as an audio speaker or light, perceptible by the user. The alarms are operable to notify individuals in the vicinity of the signal devices that the shower is occupied. The signal devices may be configured to produce a variety of alarms. For instance, the signal device 50A may include a small amplifier 60A that sends an audio signal to an alarm indicator in the form of a small speaker 70A to transmit an audio alarm to the user when the receiver 40A receives an output signal from the detector 30. Alternatively, the signal device 50B may include a magnetic tape or solid state activation circuitry employing a pre-recorded voice message that is played through a small speaker 70B when the signal device 50B receives an output alarm indication signal from the receiver 40B. The signal device 50B may also function to illuminate an LED 75B as a simple indicator light when the receiver 40B receives the activation signal from the detector 30. The signal device 50C may also include one or more lights with labels that illuminate when an output alarm indication signal is received from the receiver. When lights are used, the signal device may include a first LED labeled “occupied” that is illuminated when the signal device receives an output alarm indication signal from the receiver, and a second LED labeled “unoccupied” that is illuminated when no such signal is received from the receiver. Two or more alarm signals may be used in combination on the signal device and may be operated by a mode switch 80, as shown in FIG. 1, such as a selector switch that may be switched among different signal modes or different modes of operation such as continuous mode or periodic mode, e.g., flashing lights. An alarm type selector 82 may be provided to enable a user to select among different types of alarms. Possible alarm selections include, for example, (1) audible noise only; (2) voice message only; (3) light only; (4) light and audible noise; or (5) light and voice message.

In FIG. 2, the signal devices 50A, 50B, 50C are configured to produce three different alarm signals. Signal device 50A, located in the kitchen, connects to an amplifier 60A and a speaker 70A. The amplifier is configured to produce an audio signal that is converted to sound through the speaker. Signal device 50B, located in the laundry room, connects to an actuation circuit 60B and to a small speaker 70B and an LED 75B. The actuation circuit 60B may include a solid state chip that stores a recorded voice message that is sent as an audio signal to the speaker 70B where it is converted to sound. Signal device 50C, located in the powder room, connects to an LED 75C. The signal device 50C illuminates the LED 75C upon receiving an output signal from receiver 40C.

Although the detector and receivers may be used with electrical wiring connections, it may be desirable to eliminate wire connections and use a wireless system. This facilitates easier installation and avoids the task of feeding and concealing wires behind walls. Therefore, the detection system may be configured as a wireless system and include a radio transmitter in the motion detector that sends radio signals to the receivers. The radio signals would operate as output signals sent to the receivers to activate the signal devices.

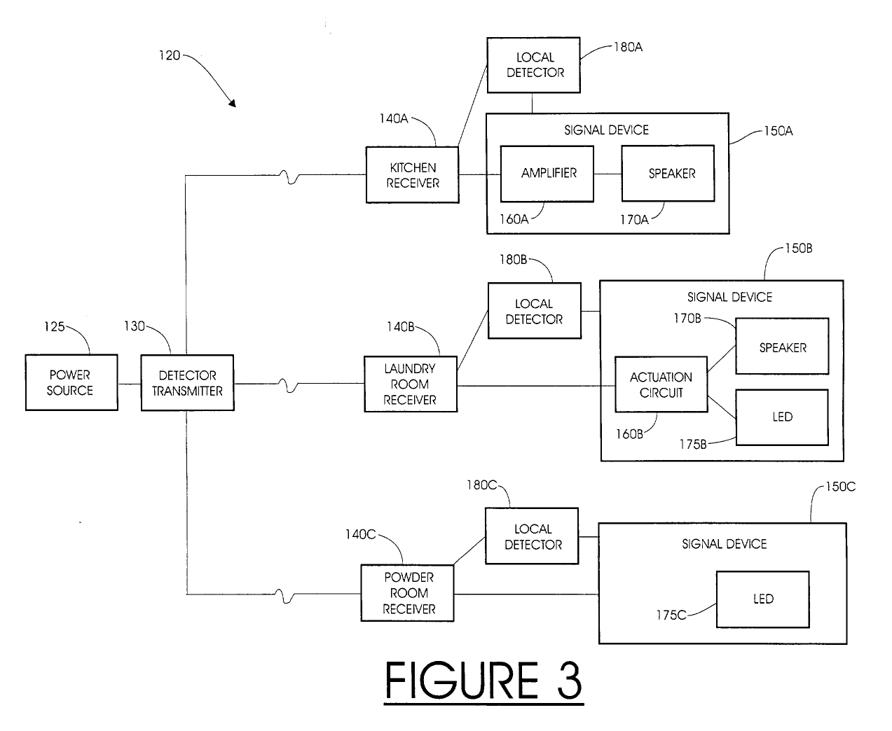

At certain times, there may be no one present in the building except the individual using the shower. In addition, individuals may be present in some but not all of the rooms containing signal devices. Therefore, it may be desirable to operate the alarm signals at selected times and locations where individuals are present. Referring now to FIG. 3, a detection system, generally designated 120, is depicted. For purpose of illustration, components that correspond to components discussed in the previously described embodiments are referenced by the same reference number plus 100. The detection system 120 is connected to a power source 125 and includes a first motion detector 130 installed in a shower. The first motion detector 130 is operatively connected to three different receivers 140A, 140B, 140C located in a kitchen, laundry room and powder room, respectively. The receivers 140A, 140B, 140C are connected to signal devices 150A, 150B, 150C, respectively. In addition, receivers 140A, 140B, 140C are operatively connected and cooperate with local detectors 180A, 180B, 180C, respectively.

The local detectors 180A, 180B, 180C may be configured as motion detectors to detect motion in the room or area in which the alarm indicators are disposed. Alternatively, the local detectors may be in the form of infrared detectors to detect a presence in the room or area in which the alarm indicators are disposed. The local detectors 180A, 180B and 180C, function to send enablement output signals to their respective receivers. Each receiver is operable to produce an alarm indicator signal to activate the associated signal device when the receiver receives both the activation output signal from the first main detector 130, and the enablement output signal from the associated local detector 180A, 180B and 180C. The alarm indicator signal from the receiver is controlled by an “AND” type switch that activates the signal device when the receiver receives both the activation output signal and the enablement output signal. In this way, each receiver is capable of activating a signal device only if motion or a presence is detected at the location where the signal device or alarm indicator is located. As such, signal devices are not activated at locations where motion or presence is not detected even if the main detector 130 detects a person in the shower.

The operation of the detection system 120 will now be described in more detail. When an individual enters a shower stall, the first main detector 130 detects the presence of a person or object beneath the shower head. When a motion detector is used, the detector 130 functions to detect motion at a focused zone of movement below the shower head to reflect the presence of the person in the shower. When infrared detectors are used in the detection system, the first main detector 130 detects the interruption of infrared light beams at a selected zone of detection beneath the shower head as a person enters or reaches into the shower stall beneath the shower head. The motion or light interruption, as applicable, is detected and converted to an output activation signal which is sent to receivers 140A, 140B, 140C. The output actuation signal is received by the “AND” switch in each receiver. The local detectors 180A, 180B, 180C continuously monitor changes or movement in their respective rooms or areas. Upon detecting changes or movement within a desired zone of movement, the local detectors send output enablement signals to their respective receivers, where the signals are received by the “AND” switch to thereby enable the receiver to actuate the desired alarm indicator upon receipt of an output activation signal from the main detector, reflecting the presence of a person in the shower. Accordingly, when the “AND” switch in each receiver receives both the activation signal from the main detector indicating that a person is in the shower and the enablement signal from the local detector indicating that another person is in the remote area to perceive the alarm, an output alarm indication signal is transmitted to the associated signal device. The signal device produces an alarm signal in response to the alarm indication signal. In operation, the alarm indication signal for the respective activated receiver 140A, 140B or 140C may be automatically switched off thereby deactivating the alarm when either the activation signal from the main detector 130 ceases to be transmitted when the motion or presence of a person in the shower is no longer detected by the main detector, or the enablement signal from the respective local detector 180A, 180B or 180C ceases to be transmitted when the motion or presence of a user in the vicinity of the respective local detector is no longer detected. As such, the alarm will shut off automatically when the person leaves the shower. Likewise, the alarm will shut off when the other person leaves the vicinity of the alarm indicator since no one will be present to see or hear the alarm. As an alternative, the alarm indicator signal may continue to be transmitted for a predetermined time period, i.e., an alarm time period, even after either or both the main detector or the local detector no longer detects a motion or presence. In order to enable the user to adjust the alarm time period, an alarm time period selector 84 may be provided, as depicted in FIG. 1. As yet another alternative, the alarm indicator signal may continue to be transmitted even after either the main detector or the local detector no longer detects a presence or motion unless the system is reset to deactivate the alarm. For this purpose, a manual reset button 89 may be provide to enable the user to manually deactivate the alarm and reset the system. If a delayed reset is desired, a time out period selector 86 may be provided to enable a user to select a time period that an alarm will remain deactivated following actuation of the alarm reset 89. Further, an alarm magnitude selector 867 may be provided to enable the user to select a desired characteristic of the alarm, such as light intensity, sound volume, or numbers of lights or speakers.

The receivers 140A, 140B and 140C, depicted in FIG. 3, may each be configured as the receiver depicted in FIG. 1. As such, the receiver 140 may include a mode switch 80 to enable the user to select the desired mode of operation of the receiver such as for producing a continuous or periodic alarm signal. The receiver 140 may also include an alarm selection switch 82 to enable the user to select the type of alarm to be activated, such as an audio alarm or a light alarm or both. An alarm time period selector 84 may be provided to enable the user to select a specific time period that the alarm will be activated. To adjust the volume of sound generated by an audio alarm or the intensity of light or the numbers of alarm lights to be illuminated, the receiver 140 may include an alarm magnitude adjustment selector 86.

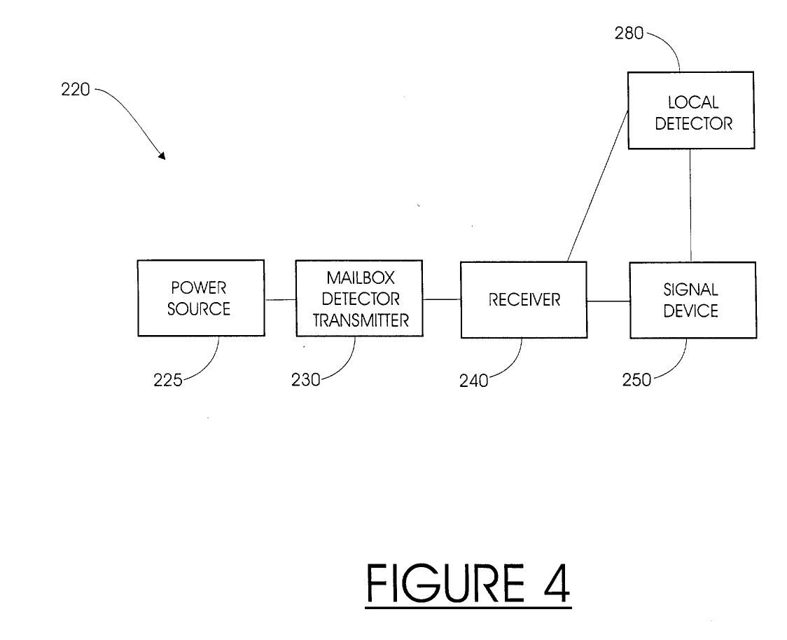

Referring now to FIG. 4, a detection system, generally designated 220, in accordance with the present invention is shown. The detection system 220 is operable to monitor a delivery receptacle, such as a mailbox, and detect when a delivery is made. The detection system 220 may be used in conjunction with the shower detection system depicted in FIGS. 1, 2 or 3. The detection system 230 may also be configured like the shower detection system shown in FIGS. 1, 2 or 3. For purposes of illustration, the detection system 220 is described when used to monitor the delivery of mail to a mailbox from inside a dwelling. A detector 230 is connected to a power source 225, such as rechargeable battery pack, and mounted inside the mailbox. The detector 230 when configured as a motion detector is operable to detect when the door to the mailbox is opened. The detector 230 when configured as an infrared detector may use a variety of sensors to detect when mail or some other object is located in the mailbox. Upon detection that the mailbox has been opened, or that an object is present in the mailbox, an output activation signal is sent from the detector 230 to one or more receivers 240 located in the dwelling to notify individuals in the dwelling that the mailbox was opened or that a deposit is in the box.

The detector 230 may be connected to one or more receivers 240, with or without wiring, depending on whether the motion detector produces electrical signals or transmits radio signals to the receivers. Each receiver 240 is adapted to receive the output activation signal from the detector 230. In response, the receiver transmits an alarm indication signal to a signal device 250, which produces an alarm signal in response to the alarm indication signal.

When a motion detector is employed, the alarm signal remains on indefinitely, or at least for a time period selected by the user via an alarm time period selector, similar to the alarm time period selector 84 in FIG. 1. This ensures that even after the mailbox door is closed, the user will receive notification that the mailbox had been opened earlier. The alarm signal may be switched off by the user in a variety of ways. For example, the system may be configured to switch off the alarm when the motion detector 230 detects that the mailbox is opened for a second time. In this configuration, the alarm signal switches off when the individual opens the mailbox to retrieve the mail. The receiver 240 may also include a manual reset button, similar to that shown in FIG. 1, that terminates the alarm when pressed. When an infrared detector is used to detect the presence of an object in the mailbox, the alarm signal will remain on as long as the infrared detector detects the presence of the object in the mailbox. As such, the system may automatically reset when the object is removed from the mailbox. The receiver 240 may be wired to the house electrical system. The detection system 220 may also include local detectors 280 mounted in the vicinity of each signal device 250 to limit operation of the alarm signals to those areas when motion or a presence is detected.

The terms and expressions which have been employed are used as terms of description and not of limitation. There is no intention in the use of such terms and expressions of excluding any equivalents of the features shown and described or any portions thereof. It is recognized, therefore, that various modifications are possible within the scope and spirit of the invention. Accordingly, the invention incorporates variations that fall within the scope of the following claims.

I claim:

1. A system for signaling when a shower stall is occupied, said system comprising:
A. a detector installed in proximity to the shower stall, said detector operable to produce an activation signal upon detecting a person in the shower stall;
B. a receiver adapted to receive the activation signal from the detector and produce an alarm indication signal; and
C. a signal device responsive to the receiver, said signal device adapted to receive the alarm indication signal and activate an alarm signal at a remote location in response to the alarm indication signal to notify any individual present at the remote location that the shower is occupied.

2. The system of claim 1, wherein the signal device comprises an audio speaker and wherein the alarm signal comprises an audible sound effect.

3. The system of claim 2, wherein the alarm signal comprises a pre-recorded voice message.

4. The system of claim 1, wherein the signal device comprises a light source and wherein the alarm signal comprises a visible light emitted from the light source.

5. The system of claim 4, wherein the signal device comprises a first light that is illuminated when the signal device receives the alarm indication signal from the receiver, and a second light that is illuminated in the absence of the alarm indication signal from the receiver.

6. A system for signaling when a shower stall is occupied, said system comprising:
A. a main detector in proximity to the shower stall, said main detector operable to produce an activation signal upon detecting a person in the shower stall;
B. a secondary detector located at a remote location, said secondary detector operable to produce an enablement signal upon detecting a person at the remote location;
C. a receiver adapted to receive the activation signal from the main detector and the enablement signal from the secondary detector, and adapted to produce an alarm indication signal upon receiving both the activation signal and the enablement signal; and
D. a signal device adapted to receive the alarm indication signal and activate an alarm signal at a remote location in response to the alarm indication signal to alert the person present at the remote location that the shower is occupied.

7. The system of claim 6, wherein the signal device comprises an audio speaker and wherein the alarm signal comprises an audible sound effect.

8. The system of claim 7, wherein the alarm signal comprises a pre-recorded voice message.

9. The system of claim 6, wherein the signal device comprises a light source and wherein the alarm signal comprises a visible light emitted from the light source.

10. The system of claim 9, wherein the signal device comprises a first light that is illuminated when the signal device receives the alarm indication signal from the receiver, and a second light that is illuminated in the absence of the alarm indication signal from the receiver.

11. A system for use in detecting when a delivery is deposited in a delivery receptacle, said system comprising:
A. a detector installed at the delivery receptacle, said detector operable to produce an activation signal upon detecting a deposit of an object into the mail receptacle;
B. a receiver adapted to receive the activation signal from the detector and produce an alarm indicator signal; and
C. a signal device responsive to the receiver, said signal device adapted to receive the alarm indication signal and activate an alarm signal at a remote location in response to the alarm indication signal to notify any individual present at the remote location that an object has been deposited in the mail receptacle.

12. The system of claim 11, wherein the signal device comprises an audio speaker and wherein the alarm signal comprises an audible sound effect.

13. The system of claim 12, wherein the alarm signal comprises a pre-recorded voice message.

14. The system of claim 11, wherein the signal device comprises a light source and wherein the alarm signal comprises a visible light emitted from the light source.

15. The system of claim 14, wherein the signal device comprises a first light that is illuminated when the signal device receives the alarm indication signal from the receiver, and a second light that is illuminated in the absence of the alarm indication signal from the receiver.

16. The system of claim 11 comprising a secondary detector located at the remote location operable to produce an enablement signal upon detection of a person at the remote location and wherein the receiver is adapted to receive the enablement signal from the secondary detector and in response produce the alarm indication signal when the receiver receives both the activation signal and the enablement signal.

17. The system of claim 1, 6, or 11 comprising a mode selector to enable selection of a desired mode of operation.

18. The system of claim 17 wherein the mode selector is configured to select at least one of a continuous alarm or a periodic alarm.

19. The system of claim 1, 6, or 11 comprising an alarm type selector to enable selection of a type of alarm.

20. The system of claim 19 wherein the alarm type selector is configured to select at least one of a light alarm and an audio alarm.

21. The system of claim 1, 6, or 11 comprising an alarm magnitude selector for adjusting a selected characteristic of an alarm.

22. The system of claim 21 wherein the alarm magnitude selector is configured to select at least a predetermined light arrangement.

23. The system of claim 1, 6, or 11 comprising a time period selector to enable the selection of a time period of activation of an alarm.

24. The system of claim 23 wherein the time period selector is configured to enable manual selection of the time period of activation of the alarm.

25. The system of claim 23 wherein the time period selector is configured to enable the time period of activation of the alarm to be maintained for the selected time period despite discontinuatuion of the activation signal from the main detector.

26. The system of claim 1, 6, or 11 comprising an alarm reset to enable an activated alarm to be deactivated.

27. The system of claim 26 wherein the alarm reset includes a manually actuatable reset to enable a user to manually reset the alarm.

28. The system of claim 26 comprising a reset timeout providing a time period that the alarm will remain deactivated following actuation of the alarm reset.

29. The system of claim 28 wherein the reset timeout includes a manually selectable timeout reset to enable a user to select the time period that the alarm will remain deactivated following actuation of the alarm reset.

30. A method for signaling when a shower stall is occupied comprising:
A. providing a detector in proximity to the shower stall, said detector operable to produce an activation signal upon detecting a person in the shower stall;
B. receiving the activation signal from the detector and in response producing an alarm indication signal; and
C. activating an alarm signal at a remote location in response to the alarm indication signal to notify any individual present at the remote location that the shower is occupied.

31. The method of claim 30 comprising the steps of providing a secondary detector at the remote location operable to produce an enablement signal upon detection of a person at the remote location and receiving the enablement signal from the secondary detector and in response producing the alarm indication signal when both the activation signal and the enablement signal are received.

32. A method for detecting when a delivery is deposited in a delivery receptacle comprising:
A. a detector installed at the delivery receptacle, said detector operable to produce an activation signal upon detecting a deposit of an object into the mail receptacle;
B. a receiver adapted to receive the activation signal from the detector and produce an alarm indicator signal; and
C. a signal device responsive to the receiver, said signal device adapted to receive the alarm indication signal and activate an alarm signal at a remote location in response to the alarm indication signal to notify any individual present at the remote location that an object has been deposited in the mail receptacle.

33. The method of claim 32 comprising the steps of providing a secondary detector at the remote location operable to produce an enablement signal upon detection of a person at the remote location and receiving the enablement signal from the secondary detector and in response producing the alarm indication signal when both the activation signal and the enablement signal are received.
